(19) United States
(12) Patent Application Publication
(10) Pub. No.: US 2019/0307165 A1
(43) Pub. Date: Oct. 10, 2019

(54) HAND-HELD SMOKE CONTAINMENT AND FILTER DEVICE

(71) Applicant: Timothy Carney, Murrells Inlet, SC (US)

(72) Inventor: Timothy Carney, Murrells Inlet, SC (US)

(21) Appl. No.: 15/948,700

(22) Filed: Apr. 9, 2018

(51) Int. Cl. A24F 13/06; B01D 53/04; B01D 46/00; F23Q 13/00

(52) U.S. Cl. CPC A24F 13/06; B01D 53/0446; B01D 46/0012; B01D 2279/35; F23Q 13/005; B01D 2253/102; B01D 2258/06; B01D 46/0041

(57) ABSTRACT

A tobacco smoke containment and filter device with built-in ignition for treating secondary and side stream tobacco smoke that includes a main body portion having an outer chamber and an inner chamber, a mouthpiece, and a housing unit that includes a cigarette ignition system, a fan and a filter. The main body portion includes an outer chamber connected to the housing unit. The mouthpiece has an opening therewith sized to accommodate a cigarette. The outer chamber includes a smoke exhaust member branching off from the exterior of the outer chamber. An inner chamber is positioned within the outer chamber and has a closed far end containing at least one air hole and a near end joined to the outer chamber forming an opening for the mouthpiece. The mouthpiece has a smoke control system that controls the inhalation and exhalation of smoke by the user. (printed circuit board).

### BACKGROUND OF THE INVENTION

### 1. Field of the Invention

The present invention relates to a portable/hand held smoke containment and filter device with built-in ignition which permits cigarette users to smoke without contaminating the environment. More particularly, this invention relates a tobacco smoke containment and filter device that treats both secondary smoke and side stream smoke.

### 2. Description of Related Art

As is well known the U.S. government has detetinined that not only is tobacco smoke injurious to the smoker's heath but the secondary smoke and side stream smoke emanating therefrom are also hazardous. In fact, it has been determined that thousands die in the United States every year from such causes. Secondary smoke is the smoke that is exhaled by a smoker and side stream smoke is the smoke that is emitted into the air from a burning cigarette. The obvious way to prevent secondary smoke and side stream smoke from injuring other smokers and non-smokers is for people not to smoke. However, despite the warnings about the hazards of smoke millions of people continue to smoke because they are addicted to the nicotine and because it is very difficult for some smokers to quit smoking.

To overcome the detrimental health problems related to smoking and the issues caused from smoke from cigarette substitutes, such as electronic cigarettes, various containment and filter devices have been proposed. A number of these proposals have been made to provide devices to minimize or eliminate secondary and/or side stream smoke. These devices often catch the secondary smoke but not the side stream smoke or visa versa. Among the proposed devices the various efforts have included devices which capture secondary smoke in some form of container or filter the tobacco smoke before release to the atmosphere. Other efforts include various filter elements. Unfortunately, these substitutes, for the most part, continue to exude either secondary smoke and/or side stream smoke to the atmosphere.

It is therefore desirable, where smoking is permitted, to provide a device that allows for smoking of cigarettes and the elimination or minimization of smoke without detriment either to living things or inanimate objects in the environment and without any inconvenience to the smoker.

### SUMMARY OF THE INVENTION

It is therefore the general object of the present invention to provide a smoke containment and filter device that prevents both secondary tobacco smoke and side stream tobacco smoke from entering the atmosphere, thus mitigating detrimental health effect or discomfort to others caused thereby.

Another object of the present invention to provide a smoke containment and filter device with a mouthpiece that easily controls the inhalation and exhalation of smoke from a burning cigarette.

Yet another object of the present invention to provide a smoke containment and filter device with a built-in cigarette ignition system.

There is provided a device for containing smoke in an enclosed space and then filtering that secondary and side stream tobacco smoke so that the atmosphere will not be contaminated by the smoke when it is exhaled and passed through the filter into the atmosphere. The smoke containment and filter of the present invention includes a mouthpiece, a main body portion comprising an outer chamber and an inner chamber and a housing unit containing a cigarette ignition system, an exhaust fan and a filter.

The main body portion is connected on one end to the mouthpiece and forms an opening therewith sized to accommodate a cigarette. The other end of the outer chamber connects to the housing unit. The outer chamber includes a tobacco smoke exhaust member branching off from the exterior of the outer chamber serving to supply air to the combustion area and is the means by which the user exhales smoke. An inner chamber is positioned concentric within the outer chamber. The inner chamber contains the lighted cigarette while the outer chamber contains the exhaust smoke admitted into the chamber by the user. The exhaust smoke in the outer chamber is furced through the filter due to the negative pressure created by the fan. The inner chamber has a closed far end containing at least one air hole and a near end joined to the outer chamber foiiiiing the opening for the mouthpiece and providing a means for holding a cigarette. The inner chamber and outer chamber are sized relative to each other to accommodate the force of the exhaust fan and to counteract it.

The mouthpiece has one end into which a cigarette is inserted and placed into the mouthpiece opening and the other end of the mouthpiece being shaped to fit into a user's mouth. In one embodiment, the mouthpiece has a smoke control system that includes a smoke passageway extending through the open interior of the mouthpiece end. A closure plate mounted in the mouthpiece prevents smoke from entering the user's mouth when the smoke passageway is closed. When the smoke passageway is in the open position air is allowed to pass through an opening in the closure plate. To open the smoke passageway a push button extends through an opening in the dorsal wall of mouthpiece. When the push button is depressed the closure plate moves away from the interior wall of the mouthpiece opening the smoke passageway. There is a spring located on the opposite side of closure plate which is depressed when the smoke passageway is open such that when the push button is released, the spring pushed the closure plate back into the closed position.

In another embodiment of the mouthpiece, the mouthpiece incorporates an end cap attached to near opening of the inner and outer chambers, which is used for routing the flow of smoke during inhalation and exhalation. This embodiment thus dispenses with the exhaust member, as exhalation and inhalation both occur directly through the mouthpiece. The endcap is adapted to the inner and outer chambers such that inhalation only occurs via the cigarette, and thus via the inner chamber, whereas exhalation occurs only via the outer chamber. In embodiments wherein the inner and outer chambers are not fused to one another, the endcap is adapted to the separated chambers in such a way as to hold them in place, concentric to one another. A flow channel routes the flow of smoke in the inner chamber through a check valve when the user inhales and through a reversely positioned check valve through the outer chamber when the user exhales. A mouthpiece cover sits on the end cap with the two check valves on either side of a separator plate.

Once the tobacco smoke is exhaled through the smoke exhaust member or mouthpiece, depending upon the embodiment, and into outer chamber the smoke goes through the opening in the far end of outer chamber, i.e., the end away from the user, and into the housing unit. The housing unit contains a cigarette ignition system, an exhaust fan having a power source and a filter. The near end of the housing unit is sized into the opening in the far end of the outer chamber. The faff draws air into the outer chamber to via the exhaust member or the mouthpiece to keep the cigarette burning at the desired rate and intensity, and also pulls smoke through the filter. The draw of the fan and the size of the opening into the housing unit is such to ensure that the flow of all the air containing smoke is passed in the direction of and through the filter.

Other objects, features and advantages of the present invention will become apparent from the following detailed description of the invention taken in conjunction with the accompanying drawings.

### BRIEF DESCRIPTION OF THE DRAWINGS

Having described the invention in general terms, reference will now be made to the accompanying drawings, which are not necessarily drawn to scale, and wherein:

FIG. 1 illustrates a cross-sectional, partially broken away perspective view of an embodiment of the smoke containment and filter device with built-in ignition of the present invention showing the relationship of the major elements;

FIG. 2 is a partly perspective view of the main body portion of the smoke containment and filter device of the present invention showing the concentric relationship of the outer chamber to the inner chamber;

FIG. 3 is a cross-sectional side view of an embodiment of the mouthpiece of the present invention illustrating the mouthpiece smoke control system in a closed position;

FIG. 4 is a cross-sectional side view of the mouthpiece of an embodiment of the present invention taken along lines 4-4 of FIG. 3;

FIG. 5 is a view of another embodiment of the mouthpiece of the present invention showing the smoke flow through the end caps; and

FIG. 6 is an exploded side view of the housing unit of an embodiment of the present invention showing an embodiment of the ignition system, the fan and the filter.

### DESCRIPTION OF THE PREFERRED EMBODIMENT(S)

The presentt, invention now will be described more fully hereinafter with reference to the accompanying drawin_{g}s, in which preferred embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art. Like numbers refer to the elements throughout.

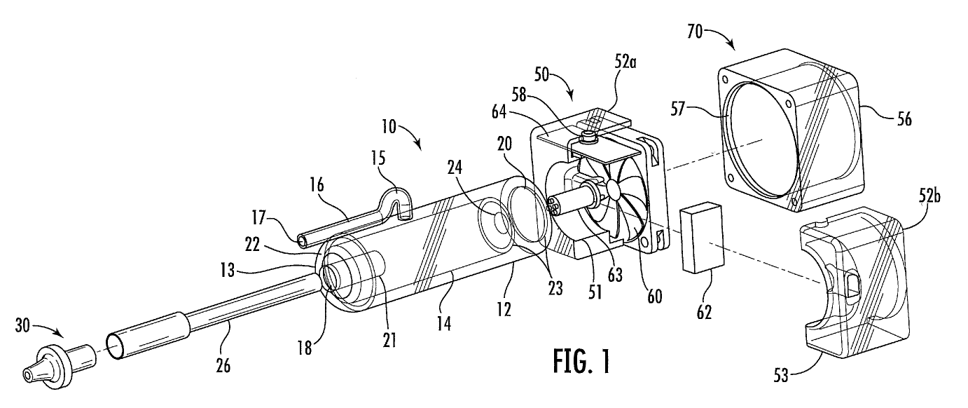

The invention describes a portable, hand-held smoke containment and filter device for treating both secondary smoke and side stream tobacco smoke. The smoke containment and filter device permits cigarette users to smoke without contaminating the environment. The aim is to allow for the smoking of cigarettes not only in private areas, wherein smoke damage will, by this device, be diminished and/or eliminated, but also in public areas, with detriment neither to living things nor inanimate objects in the environment and without any inconvenience to the smoker. As shown in FIG. 1, the smoke containment and filter of the present invention includes a mouthpiece 30, a main body portion 10 having an outer chamber 12 and an inner chamber 14, a housing unit 50 having an ignition system 62, a fan 60 and a filter 70.

The main body portion 10 includes outer chamber 12 which is connected on one end 13 to the mouthpiece 30 and forms an opening 18 therewith sized to accommodate a cigarette. The other end 20 of the outer chamber foiiiis an opening that connects to the housing unit 50. In the embodiment depicted in FIG. 1, the outer chamber 12 includes an air intake and smoke exhaust member 16 branching off from the exterior of outer chamber 12, serving to provide air to the combustion area and as the means by which the user exhales smoke directly into the outer chamber. The member 16 has one end 15 connected to the outer chamber 12 and foiiiiing an opening therewith and the other end 17 serving as an opening for exhaust smoke from the mouth of the user. The diameter of member 16 is typically a tube that is smaller than the diameter of the outer chamber, for example between ⅜ inch and ⅝ inch.

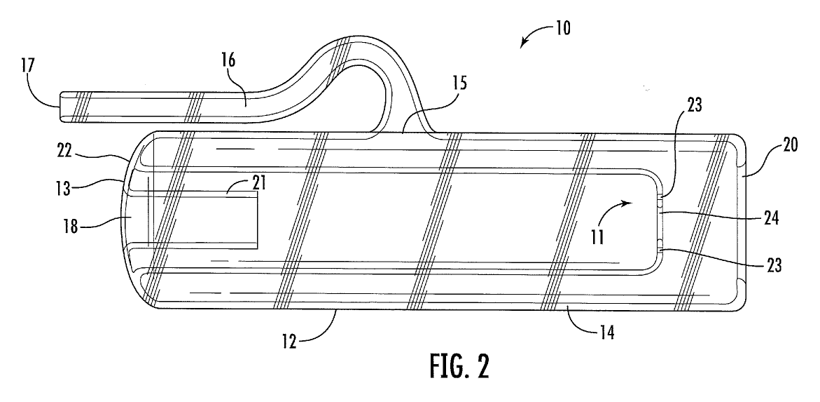

As shown in FIG. 2, inner chamber 14 is positioned concentrically within outer chamber 12 and has a near end 22 fointed with the outer chamber 12 and forming an opening 18 therewith to accept mouthpiece 30. The opening 18 for mouthpiece 30 provides a means for holding a cigarette within the mouthpiece opening 18. The opening 18 may also be provided with a short stem 21 extending into the inner chamber 14 to add stability to the mouthpiece holding the cigarette. Thus, the mouthpiece 30 may be easily removed to replace an extinguished cigarette and to replace with a fresh cigarette. Optionally, mouthpiece 30 may include an extension 26 between the mouthpiece itself and the outer chamber 12.

The far end 11 of inner chamber 14, e.g., the end away from the mouthpiece, is provided with means sufficient to supply air to support combustion of a cigarette. As noted in FIG. 2, the far end 11 of inner chamber 14 is closed. To accomplish providing the air supply for combustion of the cigarette at least one hole and preferably two or more holes are placed in the far end 11 of inner chamber 14 to allow air to enter. The holes are sized to provide sufficient oxygen to fuel the combustion of the cigarette. In a preferred embodiment, at least one of the holes 24 is sized to provide for space for ignition of a cigarette by means of an ignition system comprising either an arc or a laser. Additional holes 23 may be added to supply air for combustion of the cigarette. Main body portion 10 may be made of any durable material, but glass is preferred. The ratio of the volume of inner chamber 14 to the volume of outer chamber 12 is sufficient to provide space for air to sustain combustion of the cigarette and the removal of exhaust smoke. In other words, the outer and inner chambers are sized to accommodate and to counteract the force of the intake fan. Without the inner chamber the cigarette's burn would be disturbed by the fan and the filtration process would be disturbed by the volatile ash.

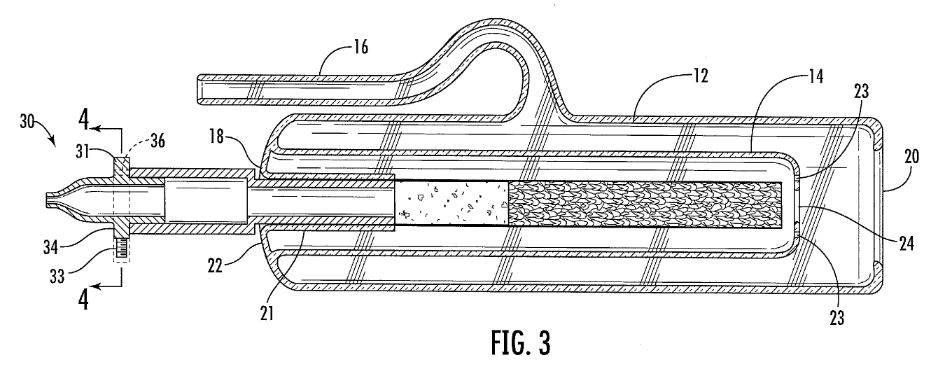

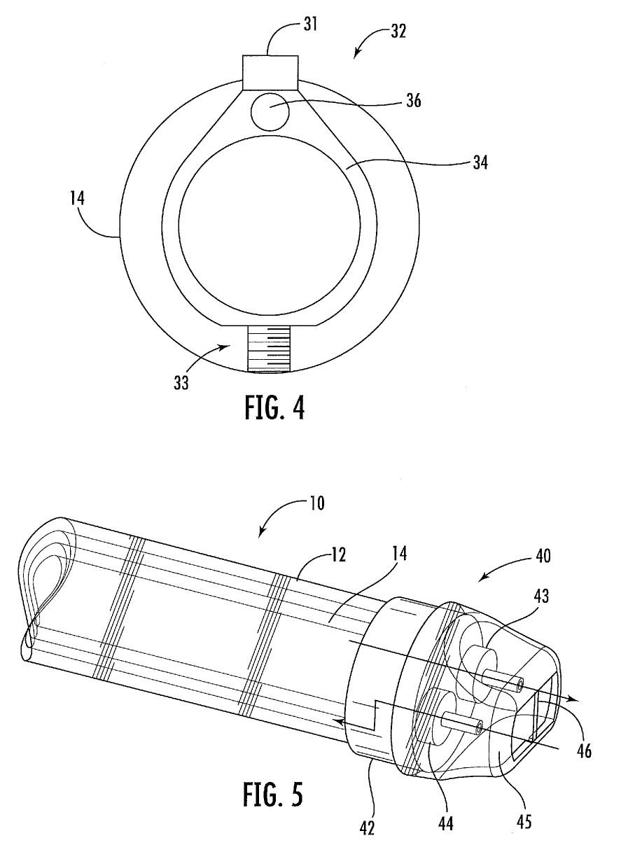

Smoke from the burning cigarette passes through the inner chamber 14 to the mouthpiece. One example of a mouthpiece 30 is shown in FIG. 3. This embodiment of the mouthpiece illustrates a mouthpiece smoke control system 32 that may be used in the device of this invention shown in the closed position depicted in FIG. 4. Mouthpiece 30 has one end sized such that when a cigarette is inserted therein the cigarette is held in place within the mouthpiece opening 18 when the mouthpiece is inserted into the near end 22 of inner chamber 14. The portion of the mouthpiece 30 that holds the cigarette may be coated with an appropriate substance, such as rubber, on the inside and outside to form an air tight seal between the mouthpiece and the mouthpiece opening 18. The other end of the mouthpiece is shaped to fit into a user's mouth.

The smoke from a burning cigarette does not automatically enter the user's mouth. In order to draw smoke into the user's mouth, the mouthpiece smoke control system 32 must be opened. The mouthpiece smoke control system 32 is shown in a closed position in FIG. 4 wherein the mouthpiece smoke control system 32 includes a closure plate 34 extending vertically through the open interior of mouthpiece 30. Closure plate 34 includes smoke passageway 36. When the smoke passageway 36 is in the open position, air is allowed to pass through an opening in the closure plate. When mouthpiece smoke control system 32 is in the closed position, the smoke passageway 36 lies between the interior and exterior sides of the dorsal mouthpiece wall preventing air from passing therethrough. To open the smoke passageway 36 a push button 31 extends through an opening in the dorsal wall of mouthpiece 30. When push button 31 is depressed closure plate 36 moves away from the interior wall of the mouthpiece opening the smoke passageway 36. There is a spring 33 located on the side of closure plate 36 opposite the smoke passageway. The spring is depressed when the smoke passageway is open. When the push button 31 is released the spring causes the closure plate to move to its closed position. The default position of the closure plate 36 is such that flow of smoke is entirely restricted until the user depresses button 31, thus opening the smoke passageway 36 and allowing the user to inhale the cigarette smoke.

In another embodiment, that shown in FIG. 5, the mouthpiece 40 includes end cap 42 holding inner chamber 14 and outer chamber 12 in concentric relationship. The end cap 42 routes the flow of smoke to and from the user. A smoke flow channel in end cap 42 routes the flow of smoke in the inner chamber 14 through inhale check valve 43 when the user inhales and through a reversely positioned exhale check valve 44 through the outer chamber 12 when the user exhales. A mouthpiece covers 45 sits on the end cap with the two check valves on either side of a separator plate 46. The separator plate 46 divides the mouthpiece into two compartments; the inhale compartment and the exhale compartment. When the user inhales from the mouthpiece 40, the smoke product from the cigarette will come out of the inner chamber to the user's mouth.

Because the gases flow in the direction of least resistance, when the user exhales smoke into the mouthpiece 40, the exhaust smoke will make its way into the exhaust chamber and flow through the exhaust check valve 44 and into the outer chamber 12. The cross-talk port, positioned between the inlet check valve and the exhaust check valve, allows any trapped exhaust smoke in the inhale chamber to pass into the mouthpiece exhaust chamber of mouthpiece 40 and finally into the outer chamber 12. By choosing the size of the cross-talk port carefully the cross talk between the two chambers can be tuned so that the smoke product from the cigarette in the inner chamber does not get sucked directly through the exhaust check valve at an unacceptable rate as the user is inhaling smoke from the cigarette.

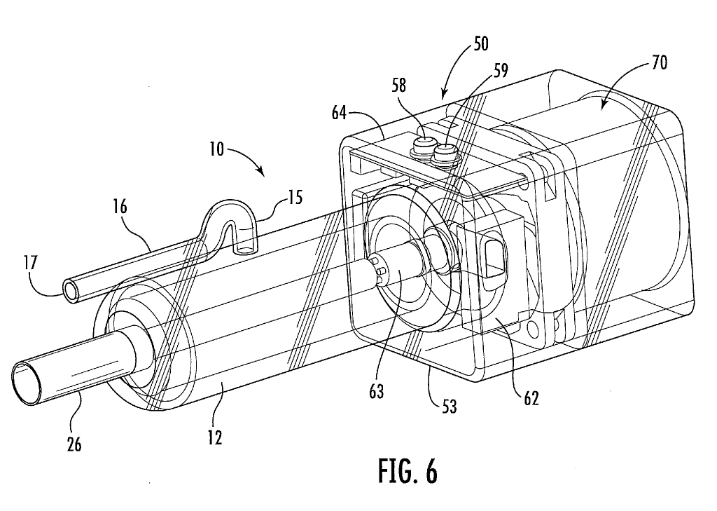

Once the tobacco smoke is exhaled through smoke exhaust member 16 (or via the valve embodiment of the mouthpiece) and into outer chamber 12 the smoke goes through the opening 20 in the far end of outer chamber 12, i.e., the end away from the user, and into housing unit 50. The housing unit 50 contains an ignition system 62, a fan 60 and a filter 70. As shown in FIG. 6, housing unit 50 is formed of sides 52a and 52b molded out of heat resistant material. The near end of housing 50 is formed into a connector 51 which is sized to fit into the opening 20 in the far end of outer chamber 12. The housing 52 may take on a variety of shapes but is general circular and preferably has a flat bottom 53.

The interior of housing 50 is configured to contain an exhaust fan 60 having a power source 62. As shown in FIG. 6 partitions molded into the housings 52a and 52b serve to position fan 60 and fan motor 54 in position. Batteries 62 for powering the fan used to withdraw exhaust smoke are contained in housing 52 and may be placed in one of several locations but as shown in FIG. 6 the batteries are connected to the PCB (printed circuit board) 64 perpendicular to it on the lateral surface of the housing and connected to the fan motor 54. The fan is turned on/off using button 58 connected to the circuitry in the PCB. The draw of the fan 60 and the size of the opening in front end 57 is such to ensure that the flow of all the air containing smoke is passed in the direction of and through the filter housing 70. The fan 60 draws air into the outer chamber 12 by means of the tube 16 or the valved version of the mouthpiece) to keep the cigarette burning at the desired rate and intensity, and pulls the exhaust smoke through the filter 70.

In one embodiment the housing unit 50 incorporates a cigarette ignition system 62. The cigarette ignition system 62 comprises a laser or arc (63) positioned in ignition mounting 61. The laser or arc is turned on using on/off button 59 and is operated by the circuitry in PCB 64 and powered by battery 62. In operation, button 59 is pressed to induce an electric arc between four electrodes or a laser. In the arc embodiment of the present invention the position of the cigarette within inner chamber 14 can be adjusted by means of a sliding control on the mouthpiece (not shown) which connects to the arc prong, via one of holes in the closed end 20 of inner chamber 14, thus being able to reach the cigarette. In the laser embodiment, the laser light travels exactly the distance required to make contact with-the cigarette.

A filter 70 is removably attached to the near end 56 of housing unit 50. One other end 57 of filter 70 is sized to be removably fitted into the end of housing unit 50. The other end of filter 70 is open for the expulsion of exhaust air. The opening is covered by a grill to keep the filter material in place and is easily removed to allow for replacement of the filter. The filter is suitably positioned within or attached to housing unit 50. The filter may be made of material conventionally used for filtering particulate matter, vapor and/or gas phase components of tobacco smoke. One example of a suitable filter material is a high energy particulate air filter (HEPA). Other examples of absorbent materials include fuller's earths, activated carbon activated clays, alumina and synthetic polymers. As the exhaust smoke comprising secondary and side stream smoke leaves the fan and passes into the filter the solid particles of the smoke are absorbed eliminating the visibility, scent and contaminating qualities of the smoke.

In a preferred embodiment, the user removes the mouthpiece 30 from the outer chamber opening 18 and inserts a cigarette into the opposite end of the mouthpiece. The mouthpiece is then reinserted, and the fan is powered on. The user then slides the mouthpiece into the outer chamber opening 18 causing the cigarette to contact the lighting element, which is activated by depressing a button located on the housing 50.

The user inhales smoke from the cigarette via the mouthpiece as normal, and exhales the smoke either into the smoke exhaust member (tube 16) or the exhaust compartment containing exhale check valve 44, depending on which of the embodiments of the mouthpiece is being used. The cigarette is extinguishable by powering off the fan and blocking tube 16 for a few seconds, which prevents air from reaching the cigarette. Once the cigarette is extinguished, the user powers on the fan by turning the power switch on; thus, purging the main body portion 10 of any remaining smoke. Once this is complete the user powers off the tobacco smoke filter and empties the ashes into an appropriate receptacle.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific temis are employed herein, they are used in a generic and descriptive sense only and not for purposes of limitation.

What is claimed is:

1. A hand-held smoke containment and filter device comprising:
(a) a main body portion comprising,
an outer chamber having one end connected to a mouthpiece opening sized to accommodate a cigarette and the other end connected to a housing unit, said outer member further comprising a smoke exhaust member having one end connected to said outer chamber and foinling an opening therewith and the other end serving as an opening for exhaust smoke from the mouth of the user and as an airway to support combustion of a cigarette;
an inner chamber within said outer chamber having a near end connected to said outer chamber and said mouthpiece opening and means to provide sufficient air to support combustion of a cigarette;
(b) a mouthpiece having one end into which a cigarette is inserted and placed into said mouthpiece opening in the near end of said inner chamber and the other end shaped to fit into a user's mouth, said mouthpiece having an airway therethrough for smoke from the combustion of said cigarette to enter the user's mouth;
(c) a housing unit directly connected to said outer chamber comprising
an ignition system for lighting said cigarette,
a fan and
a filter, said filter filtering the solid particles of the smoke, eliminating the visibility, scent and contaminating qualities of the smoke.

2. The smoke containment and filter device according to claim 1 wherein a plurality of openings is placed into the far end of said inner chamber to allow air to enter;
said openings sized to provide for ignition of a cigarette and to provide sufficient oxygen to fuel the combustion of the cigarette.

3. The smoke containment and filter device according to claim 2 wherein said plurality of holes comprises at least two holes sized to provide sufficient air to fuel the combustion of the cigarette and another hole sized to provide for ignition of a cigarette.

4. The smoke containment and filter device according to claim 1 further comprising a push button valve built into said mouthpiece to close said airway from incoming smoke thus preventing extrusion of smoke through said mouthpiece when the user exhales into said smoke exhaust member.

5. The smoke containment and filter device according to claim 1 further comprising a mouthpiece having an end cap maintaining said inner chamber and outer chamber in concentric relationship, and further containing an inhale check valve providing a passageway to said inner chamber for the passing of smoke to a user and an exhale check valve providing a passageway to said outer chamber for removing said exhaust smoke.

6. The smoke containment and filter device according to claim 1 wherein said outer chamber is made of glass.

7. The smoke containment and filter device according to claim 1 wherein said inner chamber is made of glass.

8. The smoke containment and filter device according to claim 1 wherein said smoke exhaust member branches off from said outer chamber and serves both to provide sufficient oxygen into said outer chamber and through said means to provide air into said inner chamber to fuel the combustion of the cigarette and as the means by which the user exhales smoke directly into said outer chamber.

9. The smoke containment and filter device according to claim 1 further comprising a laser operated ignition system for lighting a cigarette.

10. The smoke containment and filter device according to claim 1 further comprising an arc operated ignition system for lighting a cigarette.

11. The smoke containment and filter device according to claim 1 wherein said fan is positioned in said housing unit to draw sufficient air into the filter by means of the smoke exhaust member to keep the cigarette burning at the desired rate and intensity and passes the exhaust smoke through said filter.

12. The smoke containment and filter device according to claim 1 wherein said filter includes a gas-absorbent carbon filter.

13. The smoke containment and filter device according to claim 1 wherein said filter includes a HEPA filter.

14. A device for containing and filtering tobacco smoke comprising:
(a) a main body portion comprising,
an outer glass chamber having a far end connected to a forward portion and a nearer end connected to a mouthpiece and forming an opening therewith sized to accommodate a cigarette, said outer chamber further comprising a smoke exhaust member having one end connected to said outer chamber and forming an opening therewith and the other end serving as a mouthpiece opening for exhaust smoke from the mouth of the user;
a glass inner chamber within said outer chamber having a far end connected to a forward portion and a near end connected to a mouthpiece opening and a having plurality of openings placed into the front end of said tubular member provide sufficient air to support combustion of a cigarette; the ratio of the volume of said inner chamber to the volume of said outer chamber is sufficient to provide space for the removal of exhaust smoke;
(b) a mouthpiece having one end into which a cigarette is inserted and placed into said mouthpiece opening in the near end of said tubular member and the other end shaped to fit into a user's mouth, said mouthpiece having an airway therethrough for smoke to enter the user's mouth from the combustion of said cigarette and (c) a housing unit having a far end and a near end connected to said tubular member, said air exhaust housing having a fan and an ignition system housed therein and being directly connected to said outer chamber on one end and a filter on the other; and
(d) a filter connected to the end of said air exhaust housing opposite said outer chamber; said filter filtering the solid particles of the smoke, eliminating the visibility, scent and contaminating qualities of the smoke.

15. The tobacco smoke containment and filter device according to claim 14 further comprising a push button valve built into said mouthpiece to close said airway from incoming smoke thus preventing extrusion of smoke through said mouthpiece when the user exhales into said smoke exhaust member;

16. The tobacco smoke containment and filter device according to claim 14 further comprising said mouthpiece having an end cap maintaining said inner chamber and outer chamber in concentric relationship, and further containing an inhale check valve providing a passageway to said inner chamber for the passing of smoke to a user and an exhale check valve providing a passageway to said outer chamber for removing said exhaust smoke.

17. The tobacco smoke containment and filter device according to claim 14 wherein said plurality of holes in the front end of said inner chamber comprises at least two holes sized to provide sufficient air to fuel the combustion of the cigarette and another hole sized to provide for ignition of a cigarette.

18. The tobacco smoke containment and filter device according to claim 14 wherein said smoke exhaust member branches off from said outer chamber and serves both to provide sufficient oxygen into said outer chamber and through said means to provide air into said inner chamber to fuel the combustion of the cigarette and as the means by which the user exhales smoke directly into said outer chamber.

19. The tobacco smoke containment and filter device according to claim 14 wherein said ignition system comprises a laser.

20. The tobacco smoke containment and filter device according to claim 14 wherein said ignition system comprises an arc.

21. The tobacco smoke filter device according to claim 14 wherein said fan is positioned in said air exhaust housing to draw sufficient air into the tobacco filter device by means of the smoke exhaust member or mouthpiece to keep the cigarette burning at the desired rate and intensity and pushes a portion of the smoke through the filter.

22. The tobacco smoke filter device according-to claim 14 wherein said filter includes a HEPA filter.

23. The tobacco smoke filter device according to claim 14 wherein said filter includes a gas-absorbent carbon filter.
